(19) United States
(12) Patent Application Publication
(10) Pub. No.: US 2026/0178517 A1
(43) Pub. Date: Jun. 25, 2026

(54) CXL DEVICE AND SYSTEM

(71) Applicant: SAMSUNG ELECTRONICS CO., LTD., Suwon-si (KR)

(72) Inventors: Jin Myeong RYU, Suwon-si (KR); Bo Eok Seo, Suwon-si (KR); Young Ho Kwak, Suwon-si (KR); Oh Sung Kwon, Suwon-si (KR); Sung-Ha Kim, Suwon-si (KR); Kwang Gu Lee, Suwon-si (KR)

(73) Assignee: SAMSUNG ELECTRONICS CO., LTD., Suwon-si (KR)

(21) Appl. No.: 19/217,362

(22) Filed: May 23, 2025

(30) Foreign Application Priority Data
Dec. 24, 2024 (KR) 10-2024-0195506

(51) Int. Cl. G06F 13/16; G06F 12/02; G06F 13/42

(52) U.S. Cl. CPC G06F 13/1631; G06F 12/0246; G06F 13/4282

(57) ABSTRACT

A Compute Express Link (CXL) device, including: a CXL.io module configured to set a prefetch management capability based on a CXL.io request received from a host device; a memory controller configured to access a memory device; and a CXL.mem module configured to: receive a prefetch indicator from the CXL.io module, and prefetch first data corresponding to the at least one prefetch indicator using the memory controller, and store the prefetched first data, wherein the prefetch indicator includes address information about a prefetch region in which the first data is stored, and prefetch control/status information, and wherein the CXL.mem module is further configured to output the first data stored in the CXL.mem module to the host device based on receiving a data access request from the host device and determining that an address of requested data associated with the data access request belongs to the prefetch region.

### CROSS-REFERENCE TO RELATED APPLICATION

This application is based on and claims priority under 35 U.S.C. § 119 to Korean Patent Application No. 10-2024-0195506 filed on Dec. 24, 2024 in the Korean Intellectual Property Office, the disclosure of which is incorporated by reference herein in its entirety.

### BACKGROUND

The disclosure relates to a computer express link (CXL) device.

An apparatus configured to process data may perform various operations by accessing a memory device. For example, the apparatus may process data read from the memory device or write the processed data in the memory device. Due to performance and functions used by a system, various apparatuses that mutually perform communication through a CXL interface that provides high bandwidth and low latency may be included in the system. A memory device included in the system may be shared and accessed by two or more apparatuses. Accordingly, performance of the system may depend not only on an operating speed of each of the apparatuses but also on communication efficiency between the apparatuses and the time used for memory access.

### BRIEF SUMMARY

Provided is a system, an apparatus, and a method for reduced latency of memory access.

Also provided is a CXL system, device, and method in which, even though a memory device may be frequently accessed by a memory device, memory access latency may be reduced.

Also provided is a CXL system, device and method in which performance of the device may be improved due to reduced memory access latency, and as a result, performance of the system may be improved.

Additional aspects will be set forth in part in the description which follows and, in part, will be apparent from the description, or may be learned by practice of the presented embodiments.

In accordance with an aspect of the disclosure, a Compute Express Link (CXL) device connected to a host device and a memory device includes: a CXL host interface receiving a prefetch request including a prefetch indicator from the host device; a CXL.mem module including a prefetch module configured to prefetch first data corresponding to the prefetch indicator from the memory device, and store the prefetched first data; and a memory controller configured to access the memory device, wherein the CXL device is configured to read the first data from the prefetch module and output the first data to the host device based on the first data corresponding to requested data associated with an access request received from the host device.

In accordance with an aspect of the disclosure, a Compute Express Link (CXL) device includes: a CXL.io module configured to set a prefetch management capability based on a CXL.io request received from a host device; a memory controller configured to access a memory device; and a CXL.mem module configured to: receive at least one prefetch indicator from the CXL.io module based on the prefetch management capability being set by the CXL.io module, and prefetch first data corresponding to the at least one prefetch indicator using the memory controller, and store the prefetched first data, wherein the at least one prefetch indicator includes address information about a prefetch region in which the first data is stored, and at least one of prefetch control information and prefetch status information, and wherein the CXL.mem module is further configured to output the first data stored in the CXL.mem module to the host device based on an address of requested data associated with a data access request from the host device belonging to the prefetch region.

In accordance with an aspect of the disclosure, a Compute Express Link (CXL) device includes: a memory controller connected to a memory device in order to perform data access; and a CXL.mem module configured to: receive a CXL.mem request from a host device, decode the CXL.mem request, and based on a prefetch indicator corresponding to pre-stored first data being included in a CXL.mem request, prefetching the first data from the memory device using the memory controller, wherein the prefetch indicator includes prefetch request field information and prefetch data size field information.

The objects and effects according to the embodiment of the present disclosure are not limited to those mentioned above, and additional objects and effects of the present disclosure, which are not mentioned herein, will be more clearly understood by those skilled in the art from the following description.

### BRIEF DESCRIPTION OF THE DRAWINGS

The above and other aspects, features, and advantages of certain embodiments of the present disclosure will be more apparent from the following description taken in conjunction with the accompanying drawings, in which:

FIGS. 1 and 2 are block diagrams illustrating a CXL system according to embodiments;

FIGS. 3 and 4 are flow charts illustrating an operating method of a CXL device according to an embodiment;

FIG. 5 is a block diagram illustrating a prefetch operation of a CXL device according to an embodiment;

FIG. 6 is a view illustrating a CXL.io module in which prefetch indicator information is stored, according to an embodiment;

FIG. 7 is a flow chart illustrating an operating method of a CXL device, according to an embodiment;

FIG. 8 is a block diagram illustrating a prefetch operation of a CXL device according to an embodiment;

FIG. 9 is a view illustrating a prefetch request field including prefetch indicator information according to an embodiment;

FIG. 10 is a flow chart illustrating an operating method of a CXL device according to an embodiment;

FIG. 11 is a flow chart illustrating a prefetch operation of a CXL device according to an embodiment;

FIG. 12 is a block diagram illustrating a computing system according to an embodiment; and

FIG. 13 is a block diagram illustrating a data center to which a computing system according to an embodiment.

### DETAILED DESCRIPTION OF THE DISCLOSURE

Hereinafter, various embodiments of the present disclosure are described with reference to the accompanying drawings.

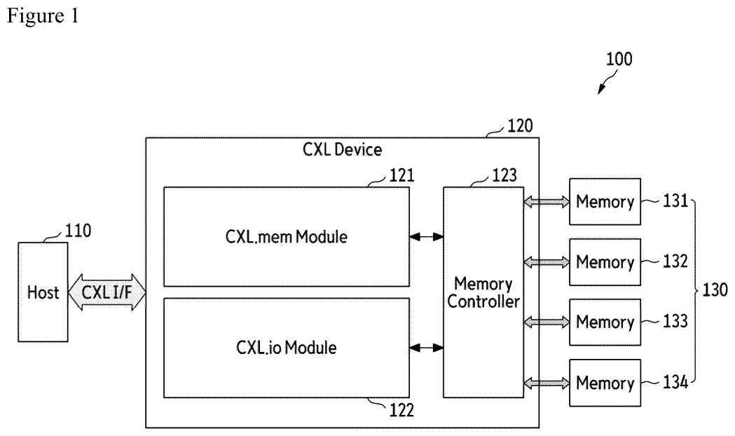

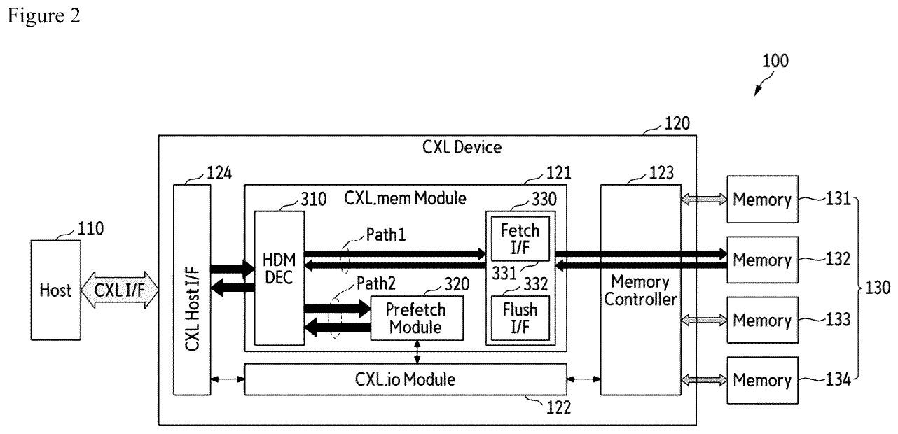

FIGS. 1 and 2 are block diagrams illustrating examples of a Compute Express Link (CXL) system according to embodiments of the present disclosure.

The CXL system 100 includes a host device 110, at least one memory device 130 (including, for example, a first memory device 130-1, a second memory device 130-2, a third memory device 130-3, and a fourth memory device 130-4), and a CXL device 120 that allows the host device 110 and the memory device 130 to perform communication with each other. For example, the CXL system 100 may be included in a stationary computing system such as a desktop computer, a server, a kiosk or the like, or may be included in a portable computing system such as a laptop computer, a mobile phone or a wearable device. In some embodiments, the CXL system 100 may be included in a system-on-chip (SoC) or a system-in-package (SiP), in which the CXL system 100 and the host device 110 are implemented in a single chip or package. As shown in FIG. 1, the CXL system 100 may include a CXL device 120 and a host device 110.

The CXL device 120 may perform communication with the host device 110 through (or using) a CXL interface (illustrated as “CXL I/F”), and may mutually transmit or receive messages and/or data on the CXL interface. Although examples are described herein with reference to a CXL interface based on CXL specification that supports CXL protocols, embodiments are not limited thereto. For example, in some embodiments, the CXL device 120 and the host device 110 may perform communication with each other based on coherent interconnect technologies such as XBus protocol, NVLink protocol, Infinity Fabric protocol, cache coherent interconnect for accelerators (CCIX) protocol, and coherent accelerator processor interface (CAPI) as non-limiting examples.

In some embodiments, the CXL interface may support multiple protocols, and messages and/or data may be transferred through the multiple protocols. For example, the CXL interface may support CXL protocols that include non-coherent protocols (e.g., CXL. io), coherent protocols (e.g., CXL.cache), and memory access protocols (or memory protocols) (e.g., CXL.mem). In some embodiments, the CXL interface may support protocols, such as peripheral component interconnect (PCI), PCI express (PCIe), universal serial bus (USB), and serial advanced technology attachment (SATA), as non-limiting example. According to embodiments, a protocol supported by the CXL interface may be referred to as an interconnect protocol.

The CXL device 120 may refer to any device that provides useful functions to the host device 110, and may correspond to an accelerator of a CXL specification in some embodiments. For example, software executed on the host device 110 may offload at least a portion of computing and/or input/output (I/O) operations to the CXL device 120. In some embodiments, the CXL device 120 may include at least one of a programmable component such as a graphical processing unit (GPU) and a natural processing unit (NPU), a component providing a fixed function such as an intellectual property (IP) core, or a reconfigurable component such as a field programmable gate array (FPGA). As shown in FIG. 1, the CXL device 120 may include a CXL host interface 124 (illustrated as “CXL Host I/F”), a CXL.mem module 121, a CXL.io module 122, and a memory controller 123, and may perform communication with the memory device 130 through the memory controller 123.

The CXL host interface 124 identifies a protocol by which a signal is transmitted to and received from the host device 110 through the CXL interface and electrically transfers the signals to the corresponding protocol module. For example, the CXL host interface 124 transfers at least one signal of a CXL.io protocol, a CXL.mem protocol or a CXL.cache protocol, which is transmitted from the host device 110 or an external device, to the CXL.mem module 121 connected to the memory access protocol, the CXL.io module 122 connected to a device access protocol, and a CXL.cache module connected to a cache access protocol in the CXL device 120, respectively. Furthermore, the CXL host interface 124 transmits at least one signal of the CXL.mem module 121, the CXL.io module 122, a CXL.mem protocol generated in the CXL.cache module, the CXL.io protocol, or the CXL.cache protocol in the CXL device 120 to the host device 110 or the external device.

The memory device 130 may be connected to the CXL device 120, and may be referred to as a device-attached memory. In some embodiments, the memory device 130 may be used as a main memory of the CXL system 100 or a system memory, but embodiments are not limited thereto. In one embodiment, the memory device 130 may include at least one of a Dynamic Random Access Memory (DRAM), a NAND (Not-AND) flash memory, a High Bandwidth Memory (HBM), a Hybrid Memory Cube (HMC), a Dual In-line Memory Module (DIMM), an Optane DIMM, a Non-Volatile Memory DIMM (NVMDIMM), a Double Data Rate Synchronous DRAM (DDR SDRAM) and a Low-Power Double Data Rate Synchronous Dynamic Random Access Memory (LPDDR SDRAM), but embodiments are not limited thereto.

The memory controller 123 may provide access of the host device 110 to the memory device 130 through the CXL interface as well as access of a component (e.g., the accelerator) in the CXL device 120 to the memory device 130. For example, in some embodiments, the memory device 130 may correspond to a device-attached memory having a CXL specification.

The host device 110 may be a main processor of the CXL system 100, for example, a central processing unit (CPU), and may correspond to a host processor (or host) of a CXL specification in some embodiments.

The CXL system 100 may have performance that depends on a bandwidth between the CXL device 120 and the memory device 130, and accordingly, a massive bandwidth may be provided between the CXL device 120 and the memory device 130. In addition, the host device 110 may access the memory device 130 through the CXL interface and the CXL device 120.

However, when the host device 110 accesses the memory device 130 frequently, there are cases where it is often difficult for the time used by a read operation between the CXL device 120 and the memory device 130 to meet latency conditions according to the CXL specification.

Therefore, it may be beneficial to reduce latency between CXL.mem request-response by prefetching data of a memory area to be frequently accessed by the CXL system 100 to the CXL device 120 in advance in order to reduce memory access through the CXL device 120.

The CXL.mem module 121 supports the host device 110 to directly access the memory device 130. Upon receiving a request requiring data access from the host device 110, the CXL.mem module 121 accesses the memory device 130 through the memory controller 123 to write data or read stored data.

In some embodiments, as shown for example in FIG. 2, the CXL.mem module 121 may include a host-managed device memory (HDM) decoder 310 (illustrated as “HDM DEC”), a prefetch module 320, and an input/output module 330.

The HDM decoder 310 manages memory mapping for an address space between the memory device 130 and the host device 110, and converts a physical address of the host device 110 into an address corresponding to the memory device 130. For example, the HDM decoder 310 manages memory mapping in connection with a CXL Type 2 device having its own memory or a CXL Type 3 device having a storage device. In addition, when receiving a request from the host device 110 through the CXL host interface 124, the HDM decoder 310 decodes the received request.

For example, when receiving a request from the host device 110, the HDM decoder 310 may decode the request into a base address in the memory device 130, a memory block size for the requested data, and a memory access attribute.

When the request is a data access request, the HDM decoder 310 decodes and extracts a data access command, an address to the memory device 130, and other information included in the request, and outputs the extracted information to at least one of the CXL.mem module 121, the CXL.io module 122, and the CXL.cache module. For example, when a CXL.mem request is received from the host device 110, the HDM decoder 310 may extract a prefetch indicator included in the CXL.mem request and transmit the prefetch indicator to the CXL.mem module 121.

When receiving a prefetch request from the host device 110, the CXL.mem module 121receives a prefetch operation for the prefetch module 320. The prefetch request of the host device 110 may be a prefetch request through the CXL.mem protocol or a prefetch request through the CXL.io protocol. For example, when the prefetch request is a prefetch request through the CXL.io protocol, the CXL device 120 may perform a prefetch operation through the prefetch indicator received from the CXL.io module 122 through a prefetch management capability setting of the device. For example, when the prefetch request is a prefetch request through the CXL.mem protocol, the CXL device 120 may perform a prefetch operation through the prefetch indicator included in the CXL.mem request.

The prefetch module 320 stores hot data among data requested by the host device 110 by prefetching the hot data from the memory device 130 in advance as a prefetch operation. According to embodiments, the hot data may refer to first data (or first-type data) and the other data except the hot data may refer to second data (or second-type data). Although terms of “first” or “second” may be used to explain various components, the components are not limited to the terms. These terms should be used only to distinguish one component from another component. For example, a “first” component may be referred to as a “second” component, or similarly, and the “second” component may be referred to as the “first” component. According to embodiments, hot data may refer to data that is frequently accessed for a predetermined time, data that is most recently accessed, or data that is repeatedly referenced in accordance with data size and importance. For example, to determine whether the corresponding data is hot data, the data or information about the data may be compared with a particular reference threshold or reference value such as Least Recently Used (LRU), Least Frequently Used (LFU), or Adaptive Replacement Cache (ARC).

According to embodiments, for convenience of description, data that is frequently and recently accessed may be referred to as hot data, and data that is rarely accessed, or not recently accessed, may be referred to as cold data or normal data.

The input/output module 330 includes a fetch interface circuit 331 (illustrated as “Fetch I/F”) and a flush interface circuit 332 (illustrated as “Flush I/F”). The fetch interface circuit 331 transmits (or fetches) new hot data read from a new prefetch region of the memory device 130 to the prefetch module 320 in response to a new prefetch request. The flush interface circuit 332 flushes corresponding data from the prefetch module 320 to the memory device 130 through the memory controller 123 in the case that the prefetch hot data becomes cold data due to its lowered access frequency and in the case that data previously stored in the prefetch module 320 is not hot data identified based on the prefetch indicator. Although the input/output module 330 is illustrated in FIG. 2 as a separate component from the prefetch module 320, embodiments are not limited thereto, and in some embodiments, the prefetch module 320 may include the input/output module 330.

The CXL.io module 122 performs device search and initialization of the CXL device 120, and supports compatibility with the PCIe interface.

In some embodiments, the CXL.cache module may manage cache coherency between devices connected to the host device 110.

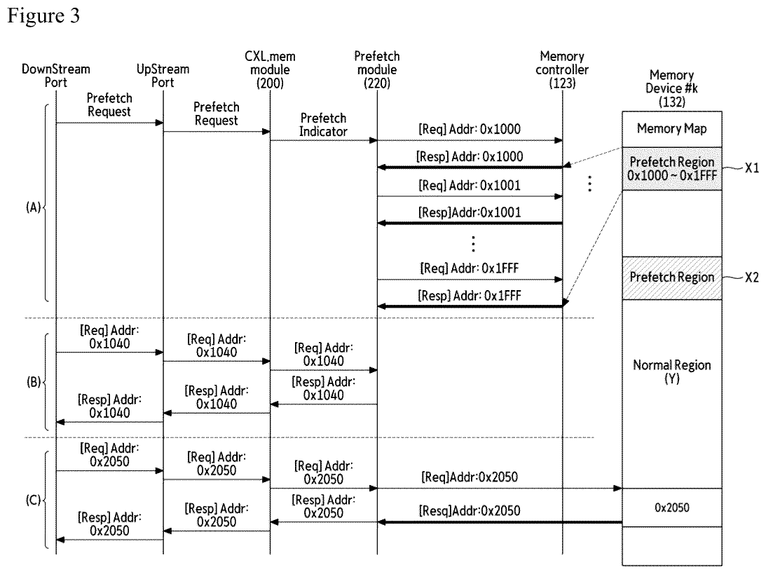

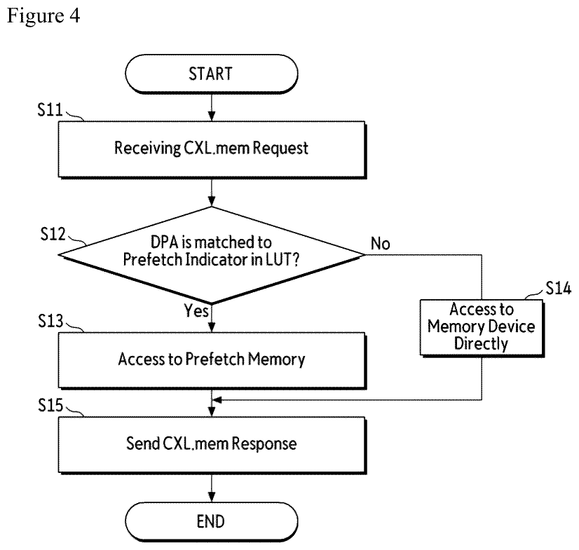

FIGS. 3 and 4 are flow charts illustrating an operating method of a CXL device according to one embodiment of the present disclosure.

Referring to FIGS. 3 and 4 together with FIG. 2, the CXL device 120 may include a downstream port and an upstream port on a root complex or a switch. The downstream port may be a port that transmits data from an upper device to a lower device, for example, transmits a transaction from the host device 110 to the root complex of the CXL device 120. In addition, the upstream port may be a port that transmits data from the lower device to the upper device, and transmits a transaction from the root complex to the CXL.mem module 121. According to embodiments, the downstream port or the upstream port may be included in the CXL host interface 124.

The CXL device 120 may perform an operation A according to a prefetch request from the host device 110, an operation B according to a data access request from the host device, and an operation C.

According to the operation A, the host device 110 transmits a prefetch request, the CXL device 120 receives the prefetch request through the downstream port and transfers the same to the CXL.mem module 121 through the upstream port. The prefetch request includes a prefetch indicator, and a protocol format of the prefetch request may be, for example, a CXL.io request, or may be, for example, a CXL.mem request.

The CXL.mem module 121 checks (or extracts) the prefetch indicator included in the prefetch request, and transmits the checked prefetch indicator to the prefetch module 320.

The prefetch module 320 checks an address of the hot data and a size of the hot data in the memory device 22 based on the information included in the prefetch indicator and accesses the prefetch region in which the hot data is positioned.

In the example shown in FIG. 3, the prefetch module 320 accesses a prefetch region X1, of which memory map address is 0x1000 to 0x1FFF, based on a first prefetch indicator, reads the hot data stored in the prefetch region X1 in advance, fetches the read hot data to the prefetch module 320, and then stores the fetched data.

According to the operation B, host device 110 may request data access during the operation. For example, when the host device 110 transmits a data access request that is received by the the CXL device 120 through the downstream port at operation S11, the CXL.mem module 121 checks whether a data address (e.g., a device physical address (DPA)) mapped to a memory inside the device included in the access request is mapped to addresses mapped to a prefetch indicator stored in a lookup table inside the prefetch module 320 at operation S12.

In the example shown in FIG. 3, when the host device 110 requests data access with an address of 0x1040 during the operation, the CXL.mem module 121 checks the address of the requested data to determine whether hot data exists. For example, the host device 110 checks whether the data address included in the access request belongs to the prefetch region X1 stored by the prefetch indicator in the prefetch module 320. When the access-requested address is identified as an address in the prefetch region X1 (Yes at operation S12), the CXL.mem module 121 regards the address as hot data, and transmits data mapped to the address 0x1040 stored in the prefetch module 320 to the host device 110 without accessing the memory device 22 at operation S13 and at operation S15.

According to the operation C, the host device 110 requests data access with an address 0x2050, and the CXL.mem module 121 checks the address of the access-requested data (which may also be referred to as “requested data”) to determine whether the hot data exists. When the access-requested address (which may also be referred to as a “requested address”) belongs to a normal region Y as an address other than the prefetch region X1 (No at operation S12), the CXL.mem module 121 accesses the access-requested address 0x2050 of the memory device 22 by regarding the address as cold data at operation S14, reads data from the memory device 22 and transmits the data to the host device 110 at operation S15.

For example, when the data requested by the host device 110 is hot data, the CXL device 120 performs data access according to Path 2 illustrated in FIG. 2, and when the data requested by the host device 110 is cold data (e.g., not hot data), the CXL device 120 performs data access according to Path 1 illustrated in FIG. 2, whereby latency reduction due to bandwidth limitations between the CXL device 120 and the memory device 130 may be reduced.

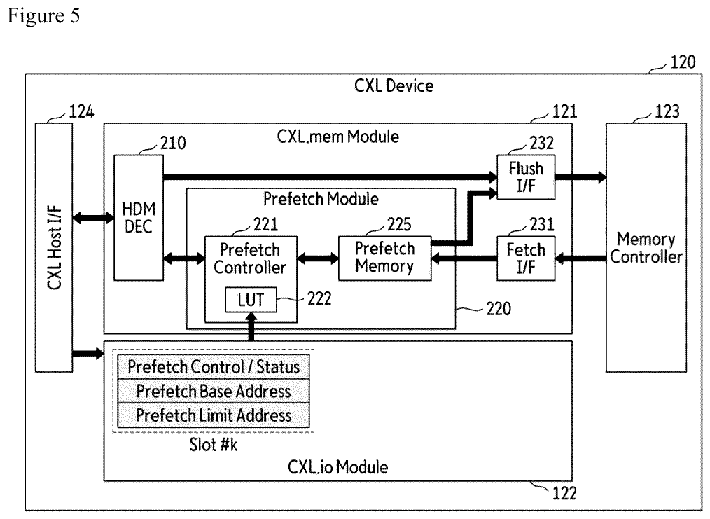

In connection with the operation A of FIG. 3, an operating method of operating the CXL device 120 according to various embodiments is described in greater detail below with reference to FIG. 5 and subsequent drawings.

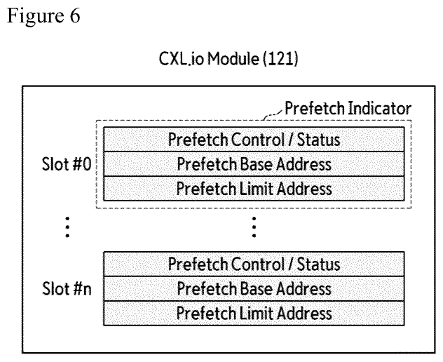

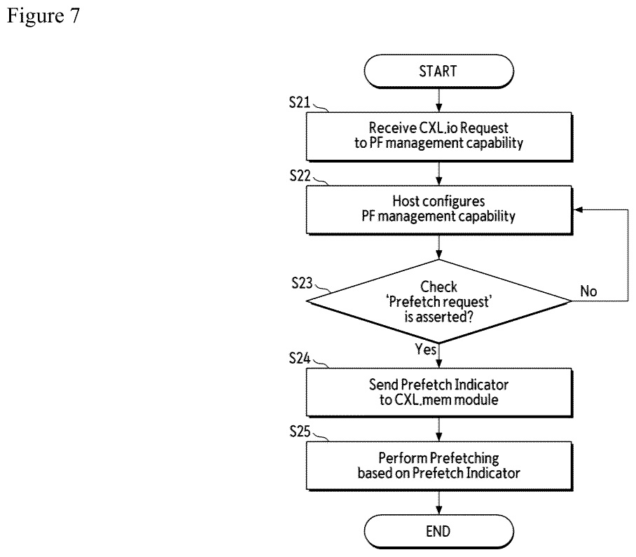

FIG. 5 is a block diagram illustrating a prefetch operation of a CXL device 120 according to an embodiment of the present disclosure, FIG. 6 is a view illustrating an CXL.io module 122 in which prefetch indicator information is stored in accordance with the embodiment of FIG. 5, and FIG. 7 is a flow chart illustrating an operating method of a CXL device 120 to describe the embodiment of FIG. 5.

Referring to FIGS. 5, 6 and 7, the CXL.io module 122 may set vendor-specific capability defined in the CXL specification. According to one embodiment, the CXL.io module 122 may set a prefetch management capability of the CXL device 120 to utilize a prefetch region in the memory device 130 by receiving the prefetch region allocated to the CXL device 120.

In an embodiment, the CXL.io module 122 includes a plurality of slots and stores the prefetch indicator for each prefetch region in each slot. The prefetch indicator includes prefetch control/status information and address information on the prefetch region. In some embodiments, the prefetch control/status information may be referred by at least one of prefetch control information and prefetch status information, but embodiments are not limited thereto. The address information of the prefetch region may include a prefetch base address and a prefetch limit address of a memory block of the memory device 130, in which hot data is stored. For example, the CXL.io module 122 includes N slots (where N is a natural number of two or more) for managing the prefetch region. The prefetch module 320 specifies at least one empty slot among the N slots previously stored in the CXL.io module due to a prefetch request, and allocates and uses address information of the prefetch region in which hot data is stored. When all the N slots are used, the prefetch module 320 regards previously stored data as cold data and flushes the previously stored data from the prefetch module with respect to slots that are not hot data, for example, slots that are already used but are not matched with the prefetch address information.

The prefetch module 220 includes a prefetch controller 221 and a prefetch memory 225. The prefetch controller 221 controls the prefetch operation by checking hot data information included in the prefetch indicator. For example, the prefetch controller 221 may store prefetch region information about the hot data based on the prefetch indicator in a lookup table 222. For example, the prefetch controller 221 may generate a hot data response according to mapping of hot data and prefetch data stored in the prefetch memory 225 based on the lookup table 222, and may control a data flush/fetch operation to the memory controller 123 according to a hot-data request.

The host device 110 transmits a prefetch (PF) management capability request to the CXL.io protocol at operation S21. When receiving the prefetch management capability request through the CXL host interface 124, the CXL.io module 122 sets the prefetch management capability so that the host device 110 may also utilize the prefetch management capability at operation S22. The CXL.io module 122 may re-check, for example, a plurality of pre-stored slots based on the prefetch management capability request, or may change, for example, information stored in at least one of the plurality of pre-stored slots based on the prefetch management capability request.

When a prefetch request is received from the host device 110 through the CXL.io protocol at operation Yes at operation S23, a prefetch indicator corresponding to the prefetch request is read from at least one of the plurality of slots stored in the CXL.io module 122 and transmitted to the CXL.mem module 121 at operation S24. The transmitted prefetch indicator may include, for example, prefetch control/status information and address information (e.g., a base address and limit address) about the prefetch region in the memory device, in which hot data is stored, as shown in FIG. 6. The CXL.io module 122 may transmit, for example, a prefetch indicator corresponding to one slot, or may transmit two or more prefetch indicators corresponding to two or more slots.

The prefetch controller 221 of the CXL.mem module 121 checks the prefetch indicator received from the CXL.io module 122, fetches hot data by accessing the prefetch region based on address information included in the prefetch indicator inside the memory device 130, and stores the fetched hot data in the prefetch memory 225 at operation S25. The prefetch memory 225 may store the fetched hot data in units of slots corresponding to the prefetch indicator.

For example, the hot data read from the memory device 130 and received through the memory controller 123 is transmitted to the prefetch memory 225 through the fetch interface circuit 231. When the hot data is received from the memory device 130, the prefetch controller 221 stores the prefetch control/status information of the prefetch indicator by changing the prefetch control/status information to indicate prefetch completion.

When the prefetch operation of the hot data is completed, the prefetch module 320 checks whether the address of the data access-requested by the host device 110 belongs to the prefetch region, for example, whether it is hot data or cold data, and may operate as in the operation B or the operation C of FIG. 3.

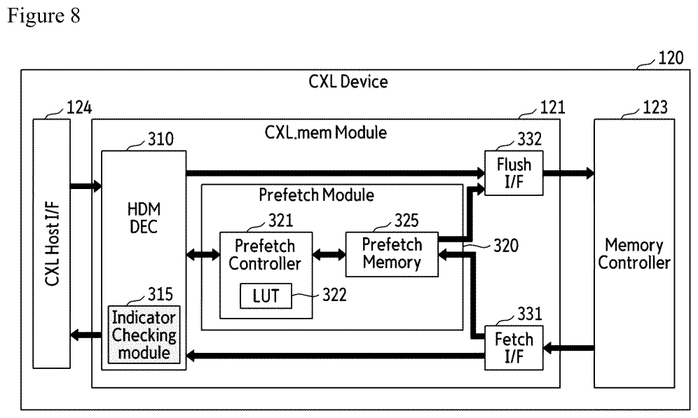

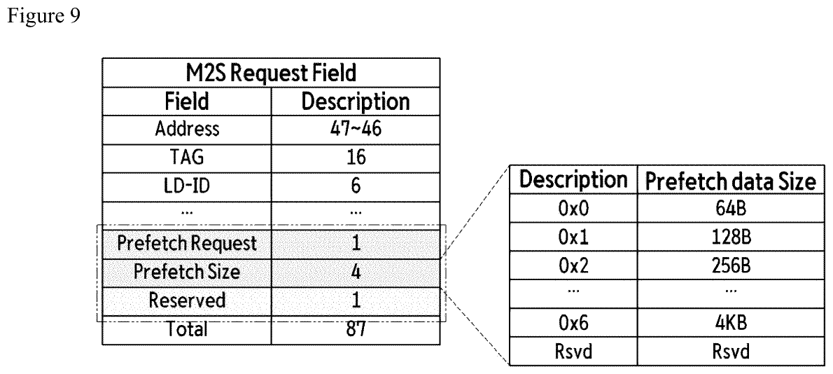

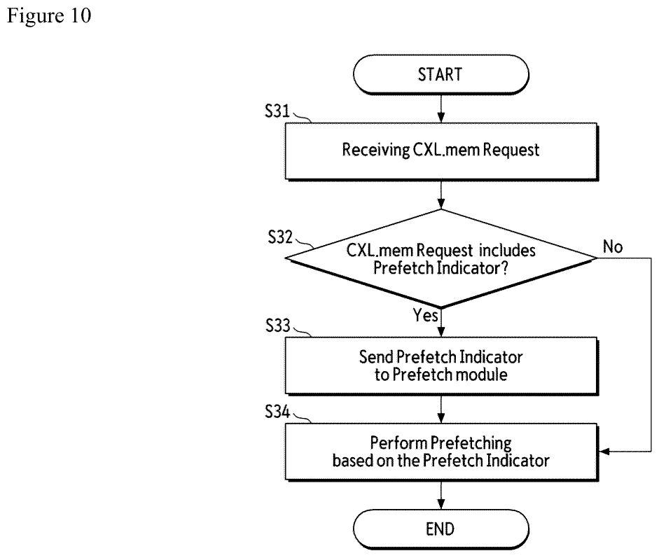

FIG. 8 is a block diagram illustrating a prefetch operation of a CXL device 120 according to one embodiment of the present disclosure, FIG. 9 is a view illustrating a prefetch request field including prefetch indicator information in accordance with the embodiment of FIG. 8, and FIG. 10 is a flow chart illustrating an operating method of a CXL device 120 to describe the embodiment of FIG. 8.

FIGS. 8, 9, and 10 relate to an example in which the CXL device 120 may perform a prefetch operation based on a prefetch indicator included in a prefetch request (e.g., a CXL.mem Request) through a CXL.mem protocol transmitted from the host device 110.

In the CXL specification, the CXL.mem request includes a total of 87 bits. The prefetch request may be included as prefetch indicator information in 6 bits defined as a reserved field of the CXL.mem request among the 87 bits.

For example, the prefetch indicator included in the CXL.mem request may include prefetch request field information and prefetch data size field information. For example, the prefetch request field may be expressed as 1 bit, and the prefetch data size field may be expressed as 4 bits. The prefetch indicator may be included in the CXL.mem request by being expressed as 0x0 when the prefetch data (or hot data) has a size of 64 Byte and as 0x1 when it has a size of 128 Bytes.

The prefetch module 320 includes a prefetch controller 321 and a prefetch memory 325. The prefetch controller 321 controls the prefetch operation by checking hot data information included in the prefetch indicator. For example, the prefetch controller 321 may store hot data mapping information of a prefetch region (e.g., prefetch region X1 of FIG. 2) corresponding to the prefetch indicator in the lookup table 322. For example, the prefetch controller 321 fetches hot data from the memory device 130 based on the lookup table 322, and then stores the fetched data in the prefetch memory 325.

For example, when the address of the access-requested data belongs to the prefetch region, the prefetch controller 321 may generate a hot-data response according to the hot data mapping, and then may control a data flush/fetch operation to the memory controller 123 according to the prefetch request (e.g., the hot-data request).

The host device 110 transmits a request (e.g., the CXL.mem Request) to the CXL.mem protocol. When the request (e.g., the CXL.mem Request) is received from the host device 110 at operation S31, an indicator checking module 315 in the HDM decoder 310 checks whether the prefetch indicator is included in the request (e.g., the CXL.mem Request) at operation S32. When the indicator checking module 315 determines that the prefetch indicator is included in the request (Yes at operation S32), the prefetch indicator of the corresponding field is transmitted to the prefetch controller 321 as the prefetch request at operation S33.

The prefetch controller 321 generates and stores the lookup table 322 for the prefetch region based on the prefetch indicator.

The prefetch controller 321 fetches data by accessing the prefetch region mapped to the address information of the prefetch indicator in the memory device 130, which is stored in the lookup table, and stores the data in the prefetch memory 325 as hot data at operation S34. In this case, the prefetch region may include up to a region set in the prefetch data size field based on an address ADD of an address field of the CXL.mem request. In the above embodiment, unlike the embodiment of FIGS. 5 to 7, the prefetch controller 321 may prefetch data by accessing one prefetch region per prefetch request.

The hot data read from the memory device 130 and received through the memory controller 123 is transmitted to the prefetch memory 325 through the fetch interface circuit 331. When the hot data is received from the memory device 130, the prefetch controller 321 stores the prefetch control/status information of the prefetch indicator by changing the prefetch control/status information to indicate prefetch completion. The prefetch memory 325 may store the fetched hot data in units of slots corresponding to the prefetch indicator.

When the prefetch operation is completed, the prefetch module 320 checks whether the data requested by the host device 110 is hot data or cold data, and may operate according to the operation B or the operation C of FIG. 3.

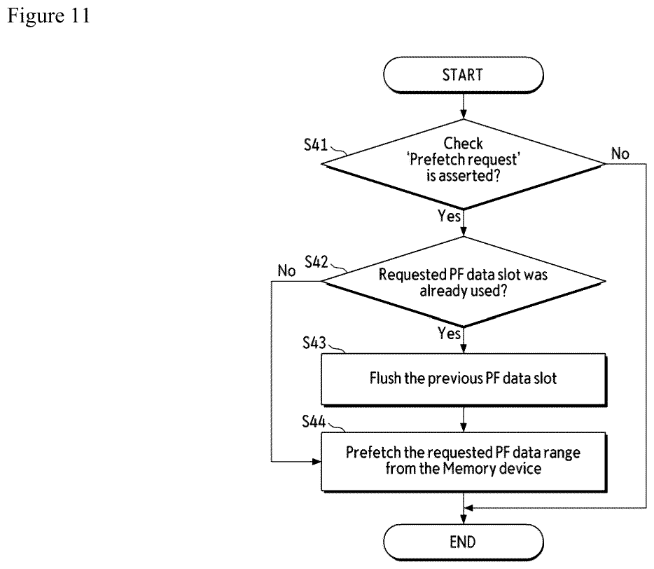

FIG. 11 is a flow chart illustrating a prefetch operation of a CXL device 120 according to one embodiment of the present disclosure.

Hot data is not permanently hot data during the operation of the CXL device, and depending on the frequency or timing of data access, the hot data may become cold data or the cold data may become the hot data.

The host device 110 may change the prefetch region in which hot data is stored, (e.g., by setting a new prefetch region), and then may transmit a new prefetch request that may be received and checked by the CXL device 120 at operation S41.

The new prefetch request may include, for example, a new prefetch indicator that includes a new address transmitted from the host device. The new prefetch request may include, for example, a new prefetch indicator corresponding to at least one slot transmitted to the prefetch module 320 as a slot newly selected in the CXL.io module 122. In some embodiments, the new prefetch request may be, for example, a CXL.mem request including a prefetch indicator that includes a new address and new size information, which is transmitted to the CXL.mem protocol.

Based on determining that the new prefetch request is received (Yes at operation S41), the CXL device 120 checks whether the slot mapped to the address information of the received prefetch request is the slot already used in the prefetch memory 325 at operation S42. When the slot is the already used slot but is not matched with the address information (Yes at operation S42), the data mapped to the corresponding slot due to the previous prefetch indicator and stored in the prefetch memory 325 is regarded as cold data and flushed at operation S43. Afterwards, based on the new prefetch indicator of the received prefetch request, new hot data having address information newly allocated to the corresponding slot is read from the memory device 130, fetched to the prefetch memory 325 and stored therein at operation S44.

When the slot of the received prefetch request is a slot which is not mapped due to other previous prefetch indicators (e.g., an unused slot) (No at operation S42), the CXL device 120 reads the hot data requested by the memory device 130 and stores the read hot data by mapping the same to the corresponding slot of the prefetch memory 325 at operation S44.

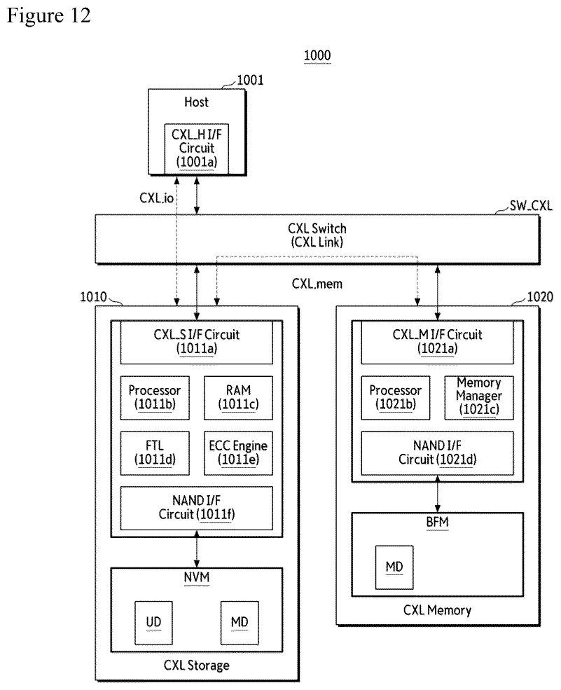

FIG. 12 is a block diagram illustrating a computing system according to some embodiments.

Referring to FIG. 12, a computing system 1000 may include a CXL switch SW_CXL, a host device 1001, a CXL storage 1010, and a CXL memory 1020. According to one embodiment, the CXL storage 1010 or the CXL m 1020 may be, or may correspond to, the CXL device 120 described with reference to FIGS. 1 to 10.

The CXL switch SW_CXL may be a component included in a CXL interface. The CXL switch SW_CXL may be configured to mediate communication among the host device 1001, the CXL storage 1010 and the CXL memory 1020. For example, when the host device 1001 and the CXL storage 1010 perform communication with each other, the CXL switch SW_CXL may be configured to transfer information such as a request, data, response or signal, which is transferred from the host device 1001 or the CXL storage 1010, to the CXL storage 1010 or the host device 1001. When the host device 1001 and the CXL memory 1020 perform communication with each other, the CXL switch SW_CXL may be configured to transfer information such as a request, data, response or signal, which is transferred from the host device 1001 or the CXL memory 1020, to the CXL memory 1020 or the host device 1001. When the CXL storage 1010 and the CXL memory 1020 perform communication with each other, the CXL switch SW_CXL may be configured to transfer information such as a request, data, response or signal, which is transferred from the CXL storage 1010 and the CXL memory 1020, to the CXL memory 1020 or the CXL storage 1010.

The host device 1001 may include a CXL host interface circuit 1001a (illustrated as “CXL_H I/F Circuit”). The CXL host interface circuit 1001a may perform communication with the CXL storage 1010 or the CXL memory 1020 through the CXL switch SW_CXL.

The CXL storage 1010 may include a CXL storage controller 1011 and a nonvolatile memory NVM. The CXL storage controller 1011 may include a CXL storage interface circuit 1011a (illustrated as “CXL_S I/F Circuit”), a processor 1011b, a RAM 1011c, a flash transformation layer (FTL) 1011d, an error correction code (ECC) engine 1011e, and a NAND interface circuit 1011f.

The CXL storage interface circuit 1011a may be connected to the CXL switch SW_CXL.The CXL storage interface circuit 1011a may perform communication with the host 101a or the CXL memory 1020 through the CXL switch SW_CXL.

The processor 1011b may be configured to control the overall operation of the CXL storage controller 1011. The RAM 1011c may be used as an operating memory or a buffer memory of the CXL storage controller 1011.

The FTL 1011d may perform various management operations for efficiently using the nonvolatile memory NVM. For example, the FTL 1011d may perform address conversion between a logical block address managed by the host device 1001 and a physical block address used in the nonvolatile memory NVM, based on map data (or a mapping table). The FTL 1011d may perform a bad block management operation for the nonvolatile memory NVM. The FTL 1011d may perform a wear leveling operation for the nonvolatile memory NVM. The FTL 1011d may perform a garbage collection operation for the nonvolatile memory NVM.

In one embodiment, the FTL 1011d may be implemented based on software, hardware, firmware, or their combination. When the FTL 1011d is implemented in the form of software or firmware, program codes related to the FTL 1011d may be stored in the RAM 1011c, and may be driven by the processor 1011b. When the FTL 1011d is implemented in hardware, hardware components configured to perform the various management operations described above may be implemented in the CXL storage controller 1011.

The ECC engine 1011e may perform error detection and correction for data stored in the nonvolatile memory NVM. For example, the ECC engine 1011e may generate parity bits for user data UD to be stored in the nonvolatile memory NVM, and the generated parity bits may be stored in the nonvolatile memory NVM together with the user data UD. In the case that the user data UD is read from the nonvolatile memory NVM, the ECC engine 1011e may detect and correct an error of the user data UD by using the parity bits read from the nonvolatile memory NVM together with the read user data UD.

The NAND interface circuit 1011f may control the nonvolatile memory NVM so that data is stored in the nonvolatile memory NVM or read from the nonvolatile memory NVM. In one embodiment, the NAND interface circuit 1011f may be implemented to comply with a standard protocol such as a toggle interface or an ONFI. For example, the nonvolatile memory NVM may include a plurality of NAND flash devices, and when the NAND interface circuit 1011f is implemented based on the toggle interface, the NAND interface circuit 1011f performs communication with the plurality of NAND flash devices through a plurality of channels. The plurality of NAND flash devices may be connected to the plurality of channels through a multi-channel-multi-way structure.

The NAND interface circuit 1011f may transmit, to each of the plurality of NAND flash devices, a chip enable signal /CE, a command latch enable signal CLE, an address latch enable signal ALE, a read enable signal /RE, and a write enable signal /WE through each of the plurality of channels. The NAND interface circuit 1011f and each of the plurality of NAND flash devices may transmit/receive a data signal DQ and a data strobe signal DQS through each of the plurality of channels.

The nonvolatile memory NVM may store or output the user data UD under the control of the CXL storage controller 1011. The nonvolatile memory NVM may store or output the map data MD under the control of the CXL storage controller 1011. In one embodiment, the map data MD stored in the nonvolatile memory NVM may include mapping information corresponding to all of the user data UD stored in the nonvolatile memory NVM. The map data MD stored in the nonvolatile memory NVM may be stored in the CXL memory 1020 during an initialization operation of the CXL storage 1010.

The CXL memory 1020 may include a CXL memory controller 1021 and a buffer memory BFM. The CXL memory controller 1021 may include a CXL memory interface circuit 1021a (illustrated as “CXL_M I/F Circuit”), a processor 1021b, a memory manager 1021c, and a buffer memory interface circuit 1021d.

The CXL memory interface circuit 1021a may be connected to the CXL switch SW_CXL.The CXL memory interface circuit 1021a may perform communication with the host 101a or the CXL storage 1010 through the CXL switch SW_CXL.

The processor 1021b may be configured to control the overall operation of the CXL storage controller 1011. The memory manager 1021c may be configured to manage the buffer memory BFM. For example, the memory manager 1021c may be configured to convert a memory address (e.g., a logical address or a virtual address) accessed from the host device 1001 or the CXL storage 1010 into a physical address for the buffer memory BFM. In one embodiment, the memory address may be an address for managing a storage area of the CXL memory 1020, and may be a logical address or a virtual address, which is designated and managed by the host device 1001.

The buffer memory interface 1021d may control the buffer memory BFM so that data is stored in or read from the buffer memory BFM. In one embodiment, the buffer memory interface circuit 1021d may be implemented to comply with a standard protocol such as a DDR interface and an LPDDR interface.

The buffer memory BFM may store data or output the stored data under the control of the CXL memory controller 1021. In one embodiment, the buffer memory BFM may be configured to store the map data MD used in the CXL storage 1010. The map data MD may be transferred from the CXL storage 1010 to the CXL memory 1020 during an initialization operation of the computing system 1000 or an initialization operation of the CXL storage 1010.

As described above, the CXL storage 1010 according to the embodiment of the present disclosure may store the map data MD required for managing the nonvolatile memory NVM in the CXL memory 1020 connected through the CXL switch SW_CXL (or the CXL interface). Subsequently, when the CXL storage 1010 performs a read operation in response to a request of the host device 1001, the CXL storage 1010 may read at least a portion of the map data MD from the CXL memory 1020 through the CXL switch SW_CXL (or the CXL interface) and perform the read operation based on the read map data MD. In some embodiments, when the CXL storage 1010 performs a write operation in response to a request of the host device 1001, the CXL storage 1010 may perform the write operation for the nonvolatile memory NVM and update the map data MD. In this case, the updated map data MD may be first stored in the RAM 1011c of the CXL storage controller 1011, and the map data MD stored in the RAM 1011c may be transferred to the buffer memory BFM of the CXL memory 1020 through the CXL switch SW_CXL (or the CXL interface) and then updated.

According to an embodiment, at least a portion of an area of the buffer memory BFM of the CXL memory 1020 may be allocated as a dedicated area for the CXL storage 1010, and the remaining area may be used as an area accessible by the host device 1001.

According to an embodiment, the host device 1001 and the CXL storage 1010 may perform communication with each other by using CXL.io that is an input/output protocol. CXL.io may have a PCIe-based non-coherent input/output protocol. The host device 1001 and the CXL storage 1010 may exchange user data or various kinds of information with each other by using CXL.io.

According to an embodiment, the CXL storage 1010 and the CXL memory 1020 may perform communication with each other by using CXL.mem that is a memory access protocol. CXL.mem may be a memory access protocol that supports access to a memory. The CXL storage 1010 may access a partial area (e.g., an area in which map data MD is stored or a CXL storage dedicated area) of the CXL memory 1020 by using CXL.mem.

According to an embodiment, the host device 1001 and the CXL memory 1020 may perform communication with each other by using CXL.mem that is a memory access protocol. The host device 1001 may access the remaining area (e.g., the remaining area other than the area in which the map data MD is stored, or the remaining area other than the CXL storage dedicated area) of the CXL memory 1020 by using CXL.mem.

The above-described access types (CXL.io, CXL.mem, etc.) are only examples, and the scope of the present disclosure is not limited thereto.

According to an embodiment, the CXL storage 1010 and the CXL memory 1020 may be mounted on a physical port (e.g., a PCIe physical port) based on the CXL interface. In one embodiment, the CXL storage 1010 and the CXL memory 1020 may be implemented based on an E1.S, E1.L, E3.S, E3.L, and PCIe AIC (CEM) form factor. In some embodiments, the CXL storage 1010 and the CXL memory 1020 may be implemented based on a U.2 form factor, an M.2 form factor, other various type of PCIe-based form factors, or other various types of small form factors. The CXL storage 1010 and the CXL memory 1020 may be implemented as various types of form factors, and may support a hot-plug function that may be mounted on or removed from the physical port.

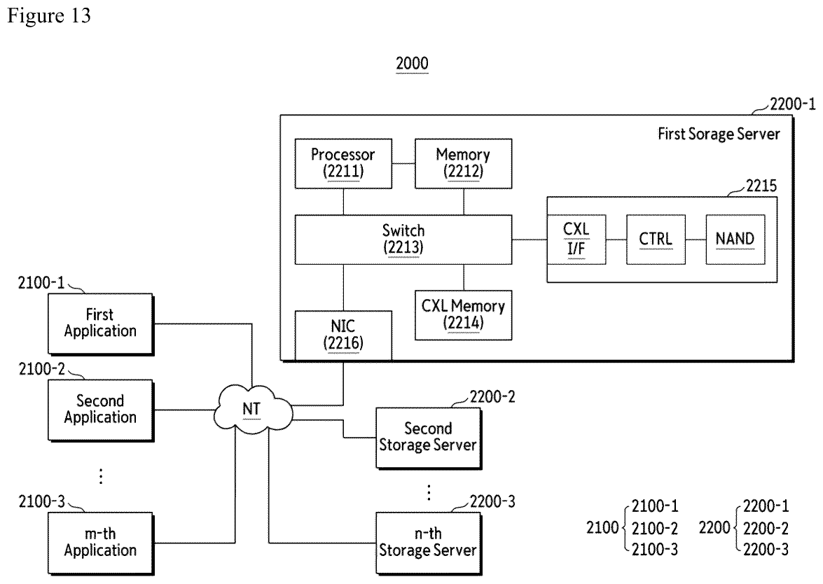

FIG. 13 is a block diagram illustrating a data center to which a computing system according to the present disclosure is applied.

Referring to FIG. 13, a data center 2000 is a facility that collects various data and provides a service, and may be referred to as a data storage center. The data center 2000 may be a system for a search engine or a database operation, and may be a computing system used in an enterprise such as a bank or a government agency. The data center 2000 may include a plurality of application servers 2100 and a plurality of storage servers 2200. For example, the plurality of application servers 2100 may include a first application server 2100-1, a second application server 2100-2, . . . , and an m-th application server 2100-m. In addition, the plurality of storage servers 2200 may include a first storage server 2200-1, a second storage server 2200-2, . . . , and an n-th storage server 2200-n. The number of application servers and the number of storage servers may be variously selected in accordance with embodiments, and the number of application servers and the number of storage servers may be different from each other.

An example of the first storage server 2200-1 is described below. Each of the application servers 2100 and each of the storage servers 2200 may have a similar structure, and the application servers 2100 and the storage servers 2200 may perform communication with each other through a network NT.

The first storage server 2200-1 may include a processor 2211, a memory 2212, a switch 2213, a storage device 2215, a CXL memory 2214, and a network interface card (NIC) 2216. The processor 2211 may control the overall operation of the first storage server 2200-1, and may access the memory 2212 to execute command languages and/or data loaded into the memory 2212. The memory 2212 may be a Double Data Rate Synchronous DRAM (DDR SDRAM), a High Bandwidth Memory (HBM), a Hybrid Memory Cube (HMC), a Dual In-line Memory Module (DIMM), an Optane DIMM and/or a Non-Volatile DIMM (NVMDIMM). The processor 2211 and the memory 2212 may be directly connected to each other, and the number of processors 2211 and the number of memories 2212, which are included in the storage server 2200, may be variously selected.

According to an embodiment, the processor 2211 and the memory 2212 may provide a processor-memory pair. According to an embodiment, the number of processors 2211 and the number of memories 2212 may be different from each other. The processor 2211 may include a single core processor or a multi-core processor. The above description of the first storage server 2200-1 may be similarly applied to each of the application servers 2100.

The switch 2213 may be configured to mediate or route communication between various components included in the first storage server 2200-1. The switch 2213 may be a switch implemented based on a CXL protocol.

The CXL memory 2214 may be connected to the switch 2213. According to an embodiment, the CXL memory 2214 may be used as a memory expander for the processor 2211. In some embodiments, the CXL memory 2214 may be allocated as a dedicated memory for the storage device 2215 or a buffer memory.

The storage device 2215 may include a CXL interface circuit CXL_IF, a controller CTRL, and a NAND flash NAND. The storage device 2215 may store data in accordance with a request from the processor 2211 or output the stored data. According to an embodiment, the storage device 2215 may be, or may correspond to, the CXL device 120 described with reference to FIGS. 1 to 11. According to an embodiment, similarly to the above description made with reference to FIGS. 1 to 11, the storage device 2215 may be allocated with at least a partial area of the CXL memory 2214 as a dedicated area, and may use the dedicated area as a buffer memory (e.g., map data may be stored in the CXL memory 2214). Also, according to an embodiment, similarly to the above description made with reference to FIGS. 1 to 11, the storage device 2215 may be allocated with at least a partial area of the CXL memory 2214 as a prefetch memory (e.g., the prefetch memory 325 of FIG. 3 and FIG. 8), and may use the prefetch memory as a memory for storing hot data.

According to some embodiments, the application servers 2100 may not include the storage device 2215. The storage server 3200 may include at least one storage device 3250. The number of storage devices 3250 included in the storage server 3200 may be variously selected in accordance with the embodiment.

The NIC 2216 may be connected to the CXL switch SW_CXL.The NIC 2216 may perform communication with other storage servers 2220 to 22n0 or other application serves 2100 through the network NT.

According to an embodiment, the NIC 2216 may include a network interface card and a network adapter. The NIC 2216 may be connected to the network NT by a wired interface, a wireless interface, a Bluetooth interface, an optical interface, or the like. The NIC 2216 may include an internal memory, a digital signal processor (DSP), and a host bus interface, and may be connected to the processor 2211 and/or the switch 2213 through the host bus interface. In one embodiment, the NIC 2216 may be integrated with at least one of the processor 2211, the switch 2213, or the storage device 2215.

In one embodiment, the network NT may be implemented using a Fibre Channel (FC) or Ethernet. In this case, the FC may refer to a medium used for relatively high-speed data transmission, and an optical switch providing high performance/high availability may be used as the FC. In accordance with an access scheme of the network NT, the storage servers may be provided as file storages, block storages or object storages.

In one embodiment, the network NT may be a storage-only network such as a storage area network (SAN). For example, the SAN may be an FC-SAN that uses an FC network and is implemented in accordance with an FC protocol (FCP). As another example, the SAN may be an IP-SAN that uses a TCP/IP network and is implemented in accordance with an SCSI over TCP/IP or Internet SCSI (iSCSI) protocol. According to an embodiment, the network NT may be a general network such as a TCP/IP network. For example, the network NT may be implemented in accordance with protocols such as FC over Ethernet (FCoE), Network Attached Storage (NAS) and NVMe over Fabrics (NVMe-oF).

At least one of the application servers 2100 may store data requested by a user or a client in one of the storage servers 2200 through the network NT. Also, at least one of the application servers 2100 may acquire the data requested by the user or the client from one of the storage servers 2200 through the network NT. For example, at least one of the application servers 2100 may be implemented as a web server or a database management system (DBMS). In one embodiment, the application servers 2100 may be the host device 110 described with reference to FIGS. 1 to 10.

In one embodiment, at least one of the application servers 2100 may access a memory, a CXL memory or a storage device, which is included in another application server, through the network NT, or may access memories, CXL memories or storage devices, which are included in the storage servers 2200, through the network NT. As a result, at least one of the application servers 2100 may perform various operations for data stored in other application servers and/or storage servers. For example, at least one of the application servers 2100 may execute command languages for moving or copying data between the other application servers and/or the storage servers. In this case, the data may be moved from the storage devices of the storage servers to the memories of the application servers or the CXL memory directly or through the memories of the storage servers or the CXL memories. The data moved through the network NT may be data encrypted for security or privacy.

In one embodiment, the storage device included in at least one of the application servers 2100 or the storage servers 2200 may be allocated with a CXL memory included in at least one of the application servers 2100 or the storage servers 2200 as a dedicated area, and the storage device may use the allocated dedicated area as a buffer memory (e.g., storing map data). For example, the storage device 2215 included in the first storage server 2200-1 may be allocated with a CXL memory included in another storage server 2200 (e.g., the n-th storage server 2200-n), and may access the CXL memory included in another storage server (e.g., the n-th storage server 2200-n) through the switch 2213 and the NIC 2216. In this case, the map data for the storage device 2215 of the first storage server 2200-1 may be stored in the CXL memory of another storage server 2200. For example, the storage devices and CXL memories of the data center according to the present disclosure may be connected and implemented in various ways.

Although some embodiments of the present disclosure are described with reference to the accompanying drawings, it will be apparent to those skilled in the art that the present disclosure may be embodied in other specific forms without departing from technical spirits and essential characteristics of the present disclosure. Thus, the above embodiments are to be considered in all respects as illustrative and not restrictive.

What is claimed is:

1. A Compute Express Link (CXL) device connected to a host device and a memory device, the CXL device comprising:
a CXL host interface receiving a prefetch request including a prefetch indicator from the host device;
a CXL.mem module including a prefetch module configured to prefetch first data corresponding to the prefetch indicator from the memory device, and store the prefetched first data; and
a memory controller configured to access the memory device,
wherein the CXL device is configured to read the first data from the prefetch module and output the first data to the host device based on the first data corresponding to requested data associated with an access request received from the host device.

2. The CXL device of claim 1, wherein the prefetch module comprises:
a prefetch memory configured to store at least one first data in at least one slot mapped to the prefetch indicator; and
a prefetch controller configured to:
store the prefetch indicator in a lookup table, and
perform data access to a slot mapped to the prefetch indicator in the prefetch memory based on an address of the requested data being matched with the prefetch indicator.

3. The CXL device of claim 1, further comprising a CXL.io module comprising a plurality of slots, each of the plurality of slots configured to store at least one prefetch indicators.

4. The CXL device of claim 3, wherein the prefetch indicator comprises and address information about a position in the memory device in which the first data is stored, and at least one of prefetch control information and prefetch status information.

5. The CXL device of claim 4, wherein the at least one of the prefetch control information and the prefetch status information indicates whether the prefetch request is received from the host device for each slot from among the plurality of slots, and whether a prefetch operation of the CXL device is completed.

6. The CXL device of claim 3, wherein the CXL.io module is further configured to:
receive the prefetch request from the host device according to a CXL.io protocol, and
based on a prefetch management capability of the CXL device being set in accordance with the prefetch request, transmit at least one prefetch indicator corresponding to the prefetch request from among the plurality of prefetch indicators to the prefetch module.

7. The CXL device of claim 6, wherein the prefetch module is further configured to:
prefetch the first data from the memory device using the memory controller based on the prefetch indicator received from the CXL.io module, and
store the prefetched first data.

8. The CXL device of claim 2, wherein the CXL.mem module further comprises a decoder configured to:
decode the prefetch request in order to extract the prefetch indicator, and
transmit the extracted prefetch indicator to the prefetch module.

9. The CXL device of claim 8, wherein the prefetch request comprises a plurality of fields, and
wherein at least one field from among the plurality of fields comprises information about the prefetch indicator.

10. The CXL device of claim 9, wherein the prefetch indicator comprises prefetch request information and prefetch data size information.

11. A Compute Express Link (CXL) device, comprising:
a CXL.io module configured to set a prefetch management capability based on a CXL.io request received from a host device;
a memory controller configured to access a memory device; and
a CXL.mem module configured to:
receive at least one prefetch indicator from the CXL.io module based on the prefetch management capability being set by the CXL.io module, and
prefetch first data corresponding to the at least one prefetch indicator using the memory controller, and
store the prefetched first data,
wherein the at least one prefetch indicator comprises address information about a prefetch region in which the first data is stored, and at least one of prefetch control information and prefetch status information, and
wherein the CXL.mem module is further configured to output the first data stored in the CXL.mem module to the host device based on an address of requested data associated with a data access request from the host device belonging to the prefetch region.

12. The CXL device of claim 11, wherein the CXL.mem module comprises:
a prefetch memory configured to store a plurality of first data corresponding to at least one slot; and
a prefetch controller configured to:
store at least one address associated with the prefetch region in a lookup table, and
control a prefetch operation according to the setting of the prefetch management capability.

13. The CXL device of claim 12, wherein the CXL.mem module is further configured to:
read the address from the prefetch memory, and
output the first data corresponding to the address to the host device based on the address being included in the at least one address stored in the lookup table.

14. The CXL device of claim 12, wherein the CXL.io module comprises a plurality of slots mapped to a plurality of prefetch indicators, and
wherein the CXL.mem module is further configured to transmit the at least one prefetch indicator to the prefetch controller according to the setting of the prefetch management capability.

15. The CXL device of claim 11, wherein the at least one of prefetch control information and prefetch status information comprises information about whether a prefetch request is received from the host device for each slot from among a plurality of slots included in the CXL.io module, and whether a prefetch operation of the CXL device is completed.

16. A Compute Express Link (CXL) device, comprising:
a memory controller connected to a memory device in order to perform data access; and
a CXL.mem module configured to:
receive a CXL.mem request from a host device,
decode the CXL.mem request, and
based on a prefetch indicator corresponding to pre-stored first data being included in a CXL.mem request, prefetching the first data from the memory device using the memory controller,
wherein the prefetch indicator comprises prefetch request field information and prefetch data size field information.

17. The CXL device of claim 16, wherein the CXL.mem module is further configured to:
check a prefetch region up to an address having a size corresponding to the prefetch data size field information based on a base address included in the CXL.mem request, and
read the first data by accessing the prefetch region of the memory device.

18. The CXL device of claim 16, wherein the CXL.mem module comprises:
a host-managed device memory (HDM) decoder configured to decode the CXL.mem request received from the host device in order to extract the prefetch indicator;
a prefetch controller configured to:
store a lookup table including data mapping information associated with a prefetch region corresponding to the extracted prefetch indicator, transmit an access request associated with the prefetch region to the memory controller, and
fetch the first data associated with the prefetch region from the memory controller; and
a prefetch memory configured to store the fetched first data.

19. The CXL device of claim 18, wherein the prefetch controller is further configured to:
based on a slot associated with the prefetch indicator being already used in the prefetch memory, flush data mapped to the prefetch indicator to the memory device through the memory controller, and
prefetch new first data corresponding to the decoded prefetch indicator from the memory device to the slot in the prefetch memory.

20. The CXL device of claim 18, wherein the CXL.mem module is further configured to:
read, from the prefetch memory, an address of requested data corresponding to the access request received from the host device, and
based on the address being included in the prefetch region stored in the lookup table, output the first data corresponding to the address to the host device.
